(19) United States
(12) Patent Application Publication
(10) Pub. No.: US 2006/0218542 A1
(43) Pub. Date: Sep. 28, 2006

(54) Redundant store-load instruction elimination based on stack location insensitive sequences

(76) Inventors: Jiangning Liu, Shanghai (CN); Yongnian Le, Shanghai (CN); Joey Ye, Shanghai (CN)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/091,239

(22) Filed: Mar. 28, 2005

(51) Int. Cl. G06F 9/45

(52) U.S. Cl. 717/154

(57) ABSTRACT

A method to eliminate redundant store and load instruction pairs in the optimization of a stack-based language comprises determining data dependencies within a sequence of instructions, identifying a store-load instruction pair within the sequence of instructions, identifying one or more stack location insensitive sequences between the store-load instruction pair that enclose one or more of the data dependencies, reordering the one or more stack location insensitive sequences based on the data dependencies to place the two instructions of the store-load instruction pair immediately adjacent to each other, and removing the store-load instruction pair.

### FIELD OF THE INVENTION

The embodiments of the invention relate generally to compilers and, more specifically, relate to elimination of redundant store-load instructions of a stack-based language by a compiler.

### BACKGROUND

Stack-based languages are used as general and special-purpose programming languages. They are popular as intermediate languages for compilers, and they are popular as machine-independent executable program representations. Examples of stack-based languages include, but are not limited to, Forth, PostScript, Java bytecode, and Microsoft Intermediate Language (MSIL).

On a register-based machine, a pair of store and load instructions that access the same local variable that does not live out of the current basic block of code may be removed if the pair does not violate any data dependencies. A basic block includes a segment of machine code with a single control flow entry and a single exit. A data dependency occurs when an instruction depends on the results of a previous instruction. On a stack-based machine, the same pair of store and load instructions may not be so easily removed. Without considering the instruction order, the simple elimination of store and load instructions would affect the stack balance because the order of instructions running on a stack-based machine is implicit to the data dependence of data elements in the stack.

In the case of a stack-based machine, translation from a register-based code to a stack-based code might produce many of such redundant store and load instructions. To make the code size smaller and more efficient to translate or execute, these redundant store and load instructions should be removed as much as possible. However, as noted above, arbitrary elimination of such redundant store-load pairs is not an option for stack-based languages.

### BRIEF DESCRIPTION OF THE DRAWINGS

The invention will be understood more fully from the detailed description given below and from the accompanying drawings of various embodiments of the invention. The drawings, however, should not be taken to limit the invention to the specific embodiments, but are for explanation and understanding only.

FIG. 1A illustrates a block diagram of one embodiment of an instruction sequence;

FIG. 1B illustrates a block diagram of one embodiment of an instruction sequence;

FIG. 2A illustrates one embodiment of a graphical depiction of an instruction sequence;

FIG. 2B illustrates another embodiment of a graphical depiction of an instruction sequence;

FIG. 3 illustrates a method to identify a SLIS according to one embodiment of the invention;

FIG. 4 illustrates a method according to one embodiment of the invention;

FIG. 5 illustrates the application of one embodiment of a method of the invention on an instruction sequence;

FIG. 6 illustrates source code for an exemplary program according to one embodiment of the invention;

FIG. 7 illustrates bytecode of an exemplary program according to one embodiment of the invention;

FIG. 8 illustrates the application of one embodiment of a method of the invention on bytecode;

FIG. 9 illustrates a pseudo-code listing according to one embodiment of the invention;

FIG. 10 illustrates a pseudo-code listing according to another embodiment of the invention; and

FIG. 11 illustrates a block diagram of an exemplary computer system used in implementing one or more embodiments of the invention.

### DETAILED DESCRIPTION

A method and apparatus to eliminate redundant store-load instructions based on stack location insensitive sequences are described. Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

In the following description, numerous details are set forth. It will be apparent, however, to one skilled in the art, that the embodiments of the invention may be practiced without these specific details. In other instances, well-known structures and devices are shown in block diagram form, rather than in detail, in order to avoid obscuring the invention.

Embodiments of the invention introduce a framework to remove redundant store and load instructions in order to optimize the code of a stack-based language. Embodiments of the invention are based on stack-based code, rather than register-based code, and may be applied on any stack-based code optimization.

In order to remove the redundant store-load instructions, embodiments of the invention split code sequences into pieces, and then reorder those pieces while keeping the stack balance unchanged and not violating any data dependencies within the sequence. The concept of a Stack Location Insensitive Sequence (SLIS) is introduced in order to perform the redundant store-load instruction optimization of embodiments of the invention. Through detecting SLISs, redundant store-load pairs can be located in order to reduce code size and improve system performance. First, a SLIS is described.

Stack Location Independent Sequence (SLIS)

An instruction running on a stack machine might change the stack state by pushing an element onto or popping an element off of the stack. The term StackVariation is defined herein as the total stack depth variation caused by a segment of sequential instructions. For example, StackVariation (STLOC)=−1, and StackVariation (LDLOC)=1. STLOC stands for a store to a local variable, and LDLOC stands for a load from a local variable.

Within a single basic block of code, a segment of sequential instructions, S, is defined as a SLIS if it meets the following two requirements:
1) The stack location is unchanged after executing the instruction sequence, S (i.e., StackVariation (S)=0); and
2) Any instruction within S does not pop up the stack elements that already exist before the instruction sequence, S, starts running.

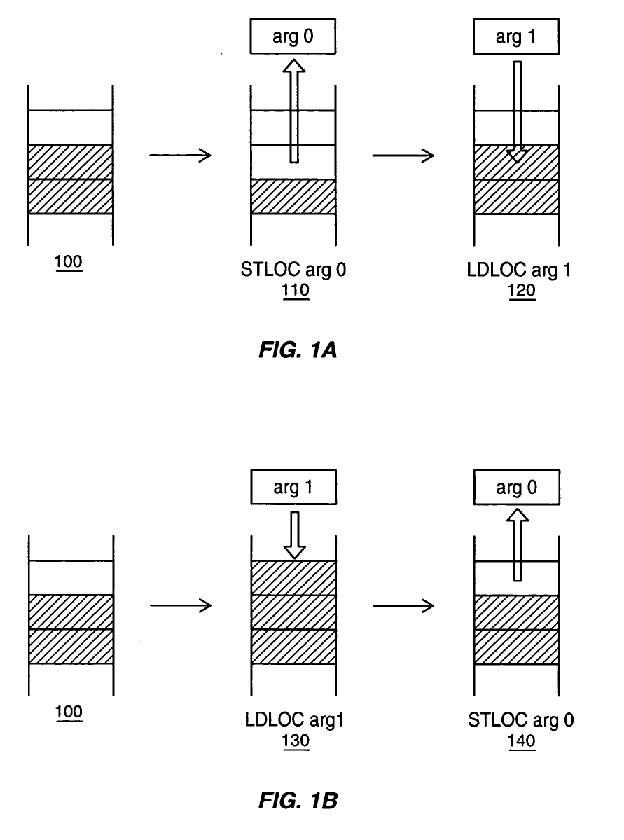

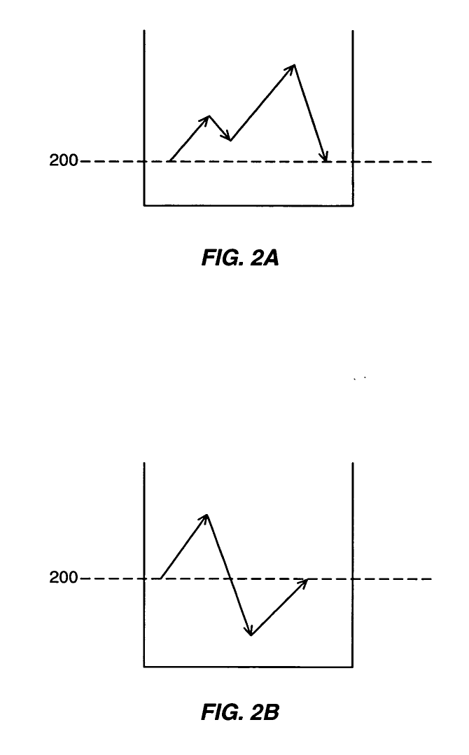

For example, in FIG. 1A, the instruction sequence 110, 120 is not a SLIS, because it violates the second rule. However, in FIG. 1B, the instruction sequence 130, 140 is a SLIS as it satisfies both requirements. In FIGS. 2A and 2B, there are two generalized stack variations graphs, in which the arrow line stands for the stack variation direction. The graph in FIG. 2A is a SLIS, while the graph in FIG. 2B is not a SLIS. The graph in FIG. 2B is not a SLIS because the lowest stack depth falls below the initial starting point 200, in violation of rule 2 above.

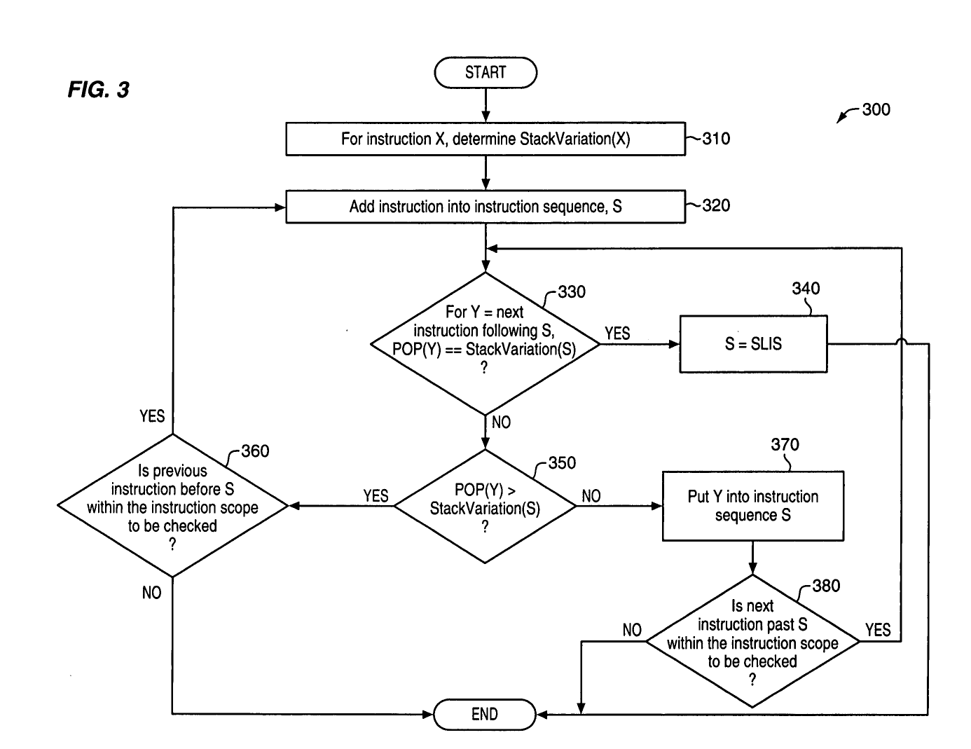

In order to perform embodiments of the invention, SLISs within an instruction sequence should be identified. Referring to FIG. 3, a method of identifying a SLIS according to one embodiment of the invention, is shown. To find a SLIS that includes an instruction, X, instructions are passed in two directions starting from X so that the potential SLIS instruction set will be enlarging and may gradually approach a desired SLIS.

At processing block 310, the StackVariation of X should be determined. For an instruction, X, StackVariation (X)=PUSH (X)−POP (X), where PUSH (X) is defined as the number of elements X pushes onto a stack, and POP (X) is defined as the number of elements X pops off of a stack. For example, for the instruction “add” in MSIL, PUSH (add)=1 and POP (add)=2. As a result, StackVariation (add)=−1. At processing block 320, X is added into instruction sequence S.

At decision block 330, a search forward is performed to observe the next instruction, Y, for the current SLIS candidate instruction sequence, S. The current StackVariation (S) is checked to determine if there are enough stack elements to equal POP (Y). If the stack elements meet the requirement of POP (Y), in other words, StackVariation (S)==POP (Y), then a SLIS has been found as shown in processing block 340.

At decision block 350, it is determined whether POP (Y)>StackVariation (S). If POP (Y)>StackVariation (S), then the method continues to processing block 360, where it is determined whether the previous instruction before instruction sequence S is within the instruction scope to be checked. If it is, then the method returns to processing block 320, where that previous instruction is added to instruction sequence S. If the previous instruction is not within the scope to be check, then the process ends without an SLIS found.

If, at decision block 350, POP (Y)<StackVariation (S), then Y is put into S at processing block 370. Then, at decision block 380, it is determined whether the next instruction past S is within the instruction scope to be checked. If it is, then the method returns to decision block 330 and the next instruction, now instruction Y, is checked to determine whether POP (Y)==StackVariation (S). If the next instruction is not within the scope to be checked, then the process ends without a SLIS found.

Significantly, a SLIS has the property of being able to be arbitrarily moved upward or downward within a basic block as long as it does not violate any data dependencies in the basic block. This is because a SLIS keeps the stack state unchanged before and after it is executed.

Method to Remove Redundant Load/Store Instructions Based on SLIS

As a SLIS has the property of being able to be moved up or down without affecting stack balance, it plays a key role in optimizing stack-based code. One embodiment of a method to eliminate redundant store-load instructions by utilizing SLISs is presented below.

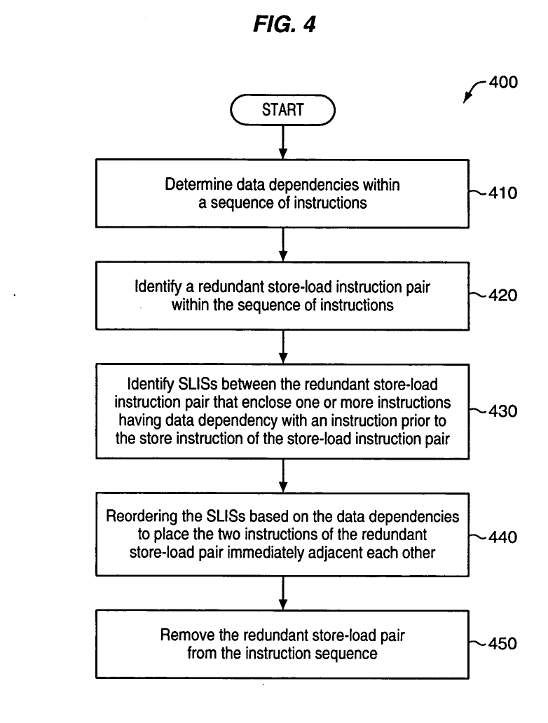

FIG. 4 is a flow diagram depicting one embodiment of a method of the invention. Method 400 eliminates a pair of redundant store-load instructions by utilizing SLISs.

At processing block 410, the data dependencies within a sequence of instructions are determined. Then, at processing block 420, a redundant store-load instruction pair within the sequence of instructions is identified. At processing block 430, one or more stack location insensitive sequences (SLISs) between the redundant store-load instruction pair are identified that encompass one or more instructions that have a data dependency with an instruction prior to the store instruction of the store-load instruction pair.

At processing block 440, the one or more SLISs of the instruction sequence that includes the redundant store-load pair are reordered, based on the data dependencies, so that the two instructions of the redundant store-load pair are immediately adjacent to each other. Finally, at processing block 450, the redundant store-load pair is removed from the instruction sequence.

The following description and figures describe a more detailed embodiment of the method 400 presented above. All of the descriptions below are within the scope of a basic block and MSIL bytecode is used to represent stack-based instructions. Of course, it should be understood that embodiments of the invention are not limited to such an implementation.

Firstly, the following symbols are defined,
Sₜ: STLOC. Store to a local variable.
L_{d}: LDLOC. Load from a local variable.
Z, X, Y, Xᵢ, Yᵢ: A segment of sequential instructions.
Dep (X, Y): True, if any instructions in X have data dependence with instructions in Y. False, otherwise.
SLIS (X): True, if X is SLIS. False, otherwise.

One embodiment of the invention utilizes a predicate, StoreLoadPair (X, Y). It is true if:
(1) X is a store instruction and Y is a load instruction;
(2) X is executed before Y in the same basic block;
(3) X and Y access the same local variable V;
(4) V does not live out of current basic block; and
(5) No instructions between X and Y depend on instruction X.

This predicate implicates that the store-load pair that returns ‘true’ can be optimized, and also has the fewest instructions between the store-load instruction pair. Those candidate redundant store-load pairs that make StoreLoadPair (X, Y) true should be identified and removed.

For example, assume the following instruction sequence pattern for a given StoreLoadPair (Sₜ, L_{d}): ZSₜ{[Xᵢ] [Yᵢ], i=1 . . . n} L_{d}

The square bracket enclosing Xᵢ means that Xᵢ may or may not exist. The same applies to Yᵢ. For example, there may be a sequence, Z SₜX₁Y₁Y₂L_{d}, in which X₂ does not exist.

In the sequence pattern above, if there are some Xs and Ys between Sₜ and L_{d}, and the instruction sequence satisfies the following rules:
(A) StoreLoadPair (Sₜ, L_{d})=True
(B) SLIS (ZSₜ)=True
(C) SLIS(Xᵢ)=False, i=1 . . . n
(D) SLIS (Yᵢ)=True, i=1 . . . n
(E) Dep (Z,Yⱼ)=True, j=1 . . . n
Dep (Z,Xᵢ)=False, i=1 . . . n
(G) Dep (Xᵢ,Yⱼ)=False, j<i,
   Then, we may transform this instruction sequence as below,
Original Sequence: ZSₜ{[X₁][Yᵢ],i=1 . . . n}L_{d}
(1)=>ZSₜ{Xᵢ,i=1 . . . n}{Yᵢ,i=1 . . . n}L_{d} . . . because (D) and (G)
(2)=>{Xᵢ,i=1 . . . n}ZSₜ{Yᵢ,i=1 . . . n}L_{d} . . . because (A), (B), and (F)
(3)=>{Xᵢ,i=1 . . . n}Z{Yᵢ,i=1 . . . n}SₜL_{d} . . . because (A) and (D)
(4)=>{Xᵢ,i=1 . . . n}Z{Yᵢ,i=1 . . . n}

Rule (G) indicates Xᵢ does not have data dependence with Yⱼ if j<i, and simultaneously rule (D) indicates Yⱼ is a SLIS. Therefore, the instructions in Yⱼ may exchange position with the instructions in Xᵢ, which does not change the stack balance. The transformation in (1) illustrates that all of Ys can be moved to the position that is subsequent to all Xs. According to the definition of the predicate StoreLoadPair, rules (A) and (F) indicate ZSₜ does not have data dependence with {Xᵢ, i=1 . . . n}, and simultaneously rule (B) indicates ZSₜ is a SLIS. Therefore, ZSₜ can exchange position with {Xᵢ, i=1 . . . n} without affecting the stack balance as seen in transformation (2).

Similarily, rule (D) indicates {Yᵢ, i=1 . . . n} is also a SLIS, and rule (A) guarantees Sₜ does not have data dependences with the Ys. Therefore, the Ys may be moved to a position prior to Sₜ, as seen in transformation (3). Finally, sequencial Sₜ L_{d} may be eliminated safely as seen in transformation (4). Notice that rules (C) and (E) are not applied for any of the transformations mentioned above, because they were used for detecting the instruction sequence pattern before the transformation.

In summation, embodiments of the invention may employ a method such as that described below:

(1): Analyze data dependences. A data dependence matrix may be constructed for all of the memory access instructions within a current basic block. The data dependences that could be analyzed include Read-Write (RW), Write-Read (WR), and Write-Write (WW). One skilled in the art will appreciate that any popular data dependence analysis method can be applied to determine the data dependencies within an instruction sequence at this point.

(2): Determine all Store-Load Pairs. Each instruction within the current basic block is examined one by one. If a store instruction is found, then go forward to find a load instruction that could make the predicate StoreLoadPair for that store-load instruction pair true. For example, without considering data dependences, in the instruction sequence { . . . STLOC.1 . . . LDLOC.1 . . . STLOC.1 . . . LDLOC.1 . . . }, the pair including the first STLOC.1 and the first LDLOC.1 should be found first, rather than the pair with the first STLOC.1 and the second LDLOC.1. Then, a store-load pair list including all of the discovered store-load pair candidates within a basic block is constructed.

(3): Split instruction sequence into SLISs. A store-load pair that has not been analyzed yet is selected from the StoreLoadPair list constructed in (2). Then, an instruction sequence, Z, ending with a STLOC instruction is located, which makes {Z, STLOC} a SLIS. Finally, the instructions that are in between the store instruction and the load instruction are analyzed to identify other SLISs that enclose the instructions that have data dependencies with Z.

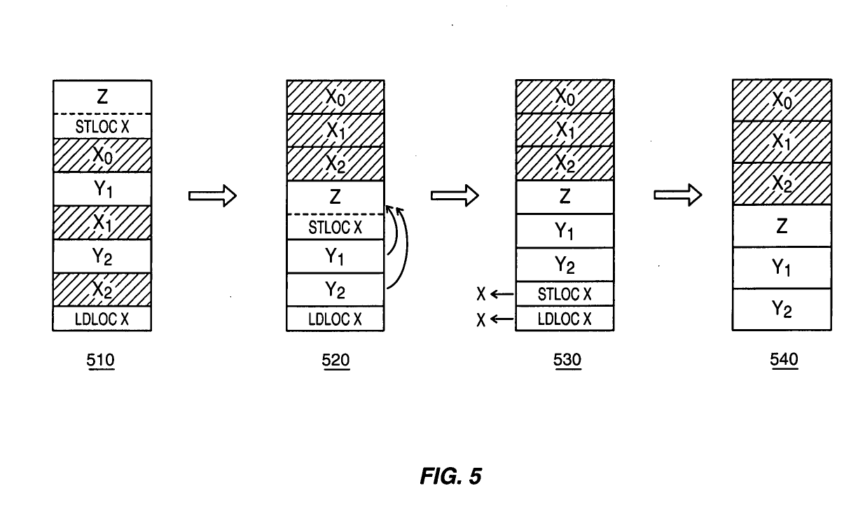

For example, as shown in FIG. 5, different instruction segments Z, X0, Y1, X1, Y2, and X2 are identified in instruction sequence 510. Both Y1 and Y2 are SLISs and have data dependences with Z. X0, X1 and X2 are not SLISs, but do not have data dependences with Z. If a SLIS cannot be found for each instruction that has data dependence with Z, then repeat (3) to try the next store-load pair we found in (2).

(4): Instruction reordering. All of the SLISs identified in (3) should be able to be moved while keeping the relative sequence unchanged. As shown in FIG. 5 at instruction sequence 520, the instruction sequence after reordering the SLISs would be {X0, X1, X2, Z, STLOC, Y1, Y2, LDLOC}. At this point, as Y1 and Y2 are SLIS and do not have any data dependence with the STLOC instruction, Y1 and Y2 can be moved above the STLOC instruction as shown in instruction sequence 530. As such, STLOC and LDLOC are immediately adjacent each other and could be eliminated simultaneously, as shown in instruction sequence 540.

After an instruction sequence has been reordered, any store-load pair that has not been analyzed yet may be analyzed by returning to (3) to continue splitting instruction sequences into SLISs for a new store-load pair. Once instruction reordering is finished, the method may be repeated from the beginning to find more store-load pairs that were, in the prior analysis, not considered removable.

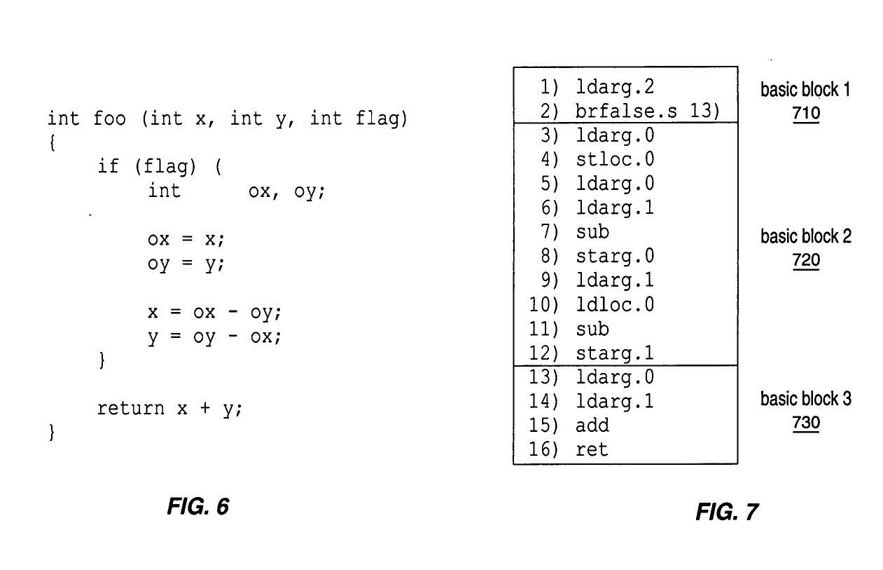

FIG. 6 presents an exemplary source code listing of a program to which an embodiment of the invention may be applied. FIG. 7 presents the program of FIG. 6, as translated into MSIL bytecode.

Instructions (4) and (10) of basic block 720 are a candidate redundant store-load pair that may be removed. To remove this pair, the instructions in basic block 720 should be split into several parts according to the method described above, and the SLISs within the instruction sequence should be identified. Then, the instructions of basic block 720 may be reordered and the redundant store-load pair removed.

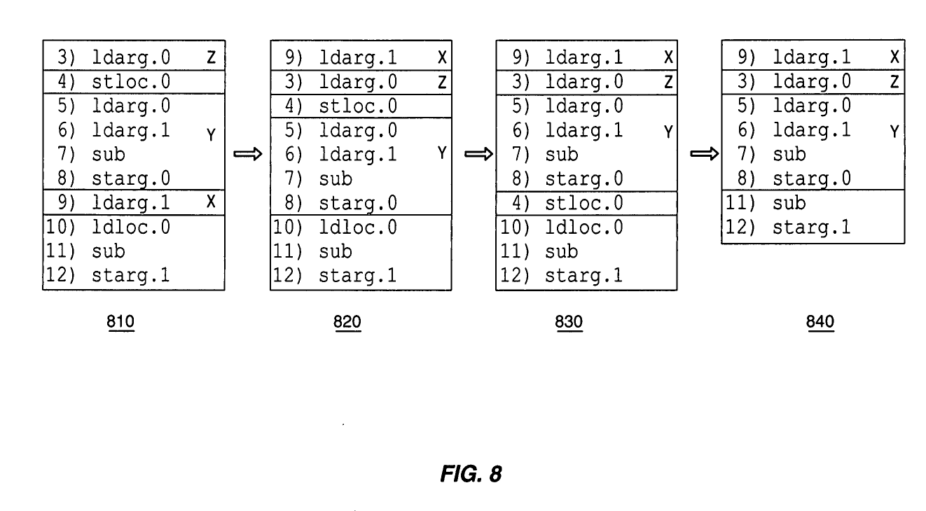

FIG. 8 illustrates the progression of applying one embodiment of a method of the invention to the MSIL bytecode listing of FIG. 7. In listing 810, both {Z, (4)} and Y are SLISs. Instruction (8) has data dependence with instruction (3), and X has no data dependence with {Z, (4)} and Y. Therefore, as shown in listing 820, {Z, (4)} and Y are moved below X. As Y is SLIS and does not have any data dependence with instruction (4), Y can be moved above instruction (4) as illustrated in listing 830. Finally, in listing 840, stloc.0 (instruction (4)) and Idloc.0 (instruction (10)) are eliminated simultaneously as they are a redundant store-load instruction pair.

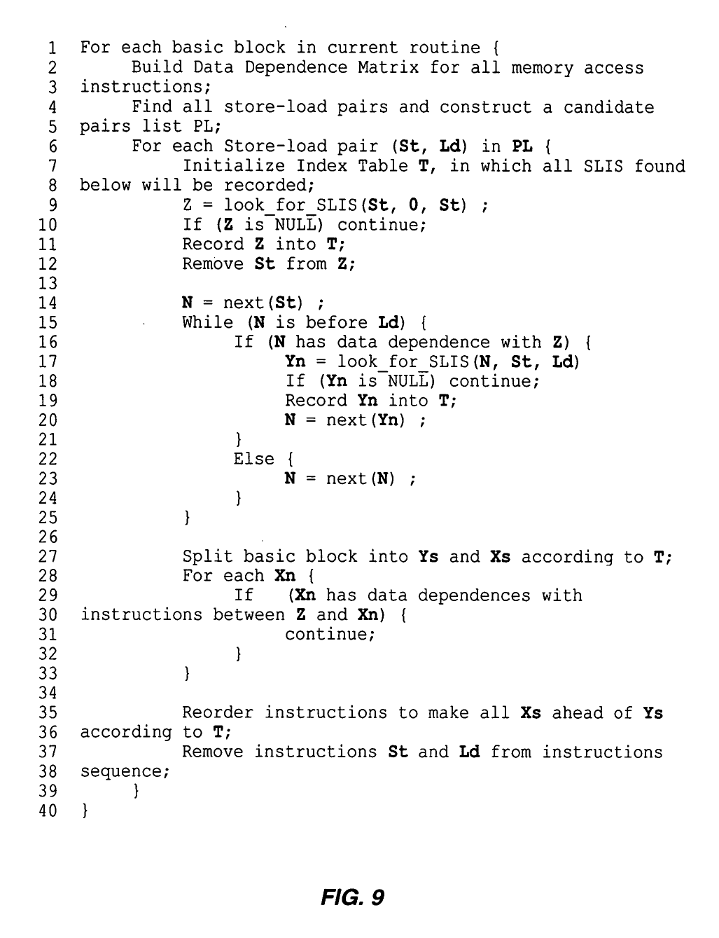

FIG. 9 depicts pseudo-code for one embodiment of the invention. The pseudo-code implements an embodiment of the method described above. At line 2 of the pseudo-code listing, data dependencies are analyzed. At line 4, all candidate store-load pairs are identified and placed in a list. At line 6, each store-load pair is analyzed for SLISs. At lines 16 and 29, data dependencies are checked to satisfy the SLIS reordering requirement. At line 27, the instruction sequence is split according to the store-load pairs and SLISs. Then at line 35, the instructions are reordered.

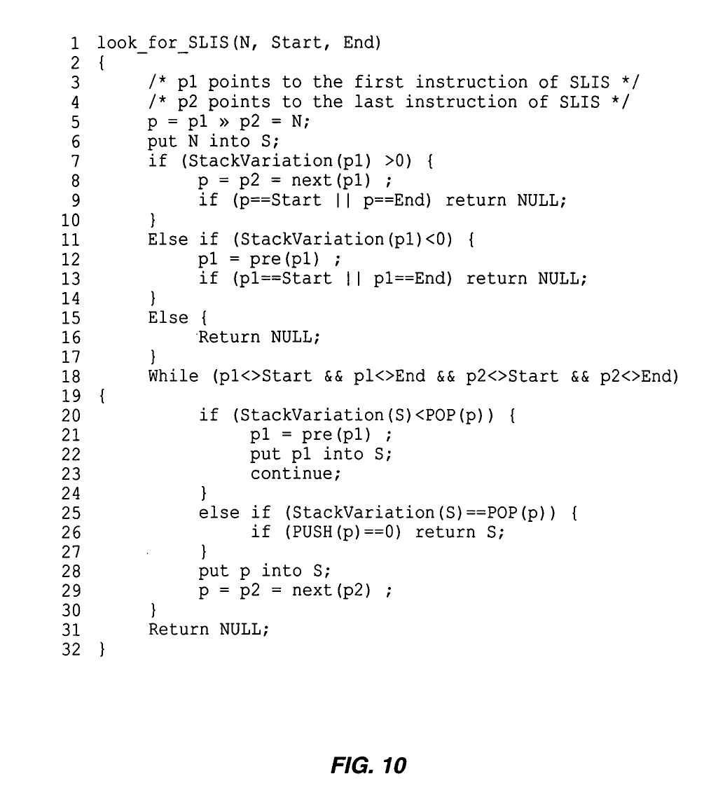

FIG. 10 depicts pseudo-code for one embodiment of finding an SLIS in an instruction sequence. In the pseudo-code listing, the procedure of locating a SLIS is named ‘look_for_SLIS’. Such a procedure would be implemented in the pseudo-code listing of FIG. 9 at lines 9 and 17.

Alternative embodiments of the invention may utilize other optimizations based on identifying a SLIS. For example, an optimization to reduce code size by generating more duplicate (DUP) instructions through utilization of SLISs may be employed. Embodiments of the invention may also be applied as a redundant store-load optimization to any stack-based code product. For example, redundant store-load optimization of floating point stack code may be performed. One skilled in the art will appreciate the range of options for utilizing a SLIS to optimize code.

Embodiments of the invention may be implemented in a variety of compilers. For instance, implementation is possible in a static compiler or a just-in-time (JIT) compiler.

The time complexity of embodiments of the invention may be lower than other optimization methods. Ordinarily, data dependence information is updated by other optimizations. Therefore, the optimization presented here need not compute it again and may utilize that data dependence information directly. Furthermore, the reordering overhead penalty from repeated reordering is avoided by detecting the SLISs. The instruction pattern for each store-load pair is detected once by examining the instructions between a store and load instruction pair, thereby avoiding the repeated reordering.

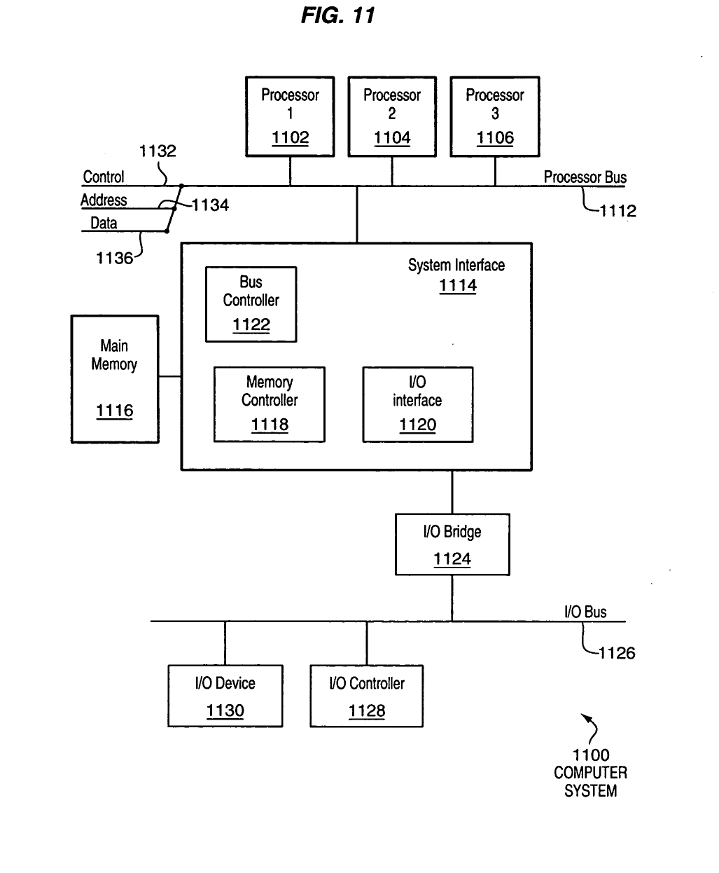

FIG. 11 is a block diagram illustrating an exemplary computer system used in implementing one or more embodiments of the invention. The computer system (system) includes one or more processors 1102-1106. The processors 1102-1106 may include one or more single-threaded or multi-threaded processors. A typical multi-threaded processor may include multiple threads or logical processors, and may be capable of processing multiple instruction sequences concurrently using its multiple threads. Processors 1102-1106 may also include one or more internal levels of cache (not shown) and a bus controller or bus interface unit to direct interaction with the processor bus 1112.

Processor bus 1112, also known as the host bus or the front side bus, may be used to couple the processors 1102-1106 with the system interface 1114. Processor bus 1112 may include a control bus 1132, an address bus 1134, and a data bus 1136. The control bus 1132, the address bus 1134, and the data bus 1136 may be multidrop bi-directional buses, e.g., connected to three or more bus agents, as opposed to a point-to-point bus, which may be connected only between two bus agents.

System interface 1114 (or chipset) may be connected to the processor bus 1112 to interface other components of the system 1100 with the processor bus 1112. For example, system interface 1114 may include a memory controller 1118 for interfacing a main memory 1116 with the processor bus 1112. The main memory 1116 typically includes one or more memory cards and a control circuit (not shown). System interface 1114 may also include an input/output (I/O) interface 1120 to interface one or more I/O bridges or I/O devices with the processor bus 1112. For example, as illustrated, the I/O interface 1120 may interface an I/O bridge 1124 with the processor bus 1112. I/O bridge 1124 may operate as a bus bridge to interface between the system interface 1114 and an I/O bus 1126. One or more I/O controllers and/or I/O devices may be connected with the I/O bus 1126, such as I/O controller 1128 and I/O device 1130, as illustrated. I/O bus 1126 may include a peripheral component interconnect (PCI) bus or other type of I/O bus.

System 1100 may include a dynamic storage device, referred to as main memory 1116, or a random access memory (RAM) or other devices coupled to the processor bus 1112 for storing information and instructions to be executed by the processors 1102-1106. Main memory 1116 may also be used for storing temporary variables or other intermediate information during execution of instructions by the processors 1102-1106. System 1100 may include a read only memory (ROM) and/or other static storage device coupled to the processor bus 1112 for storing static information and instructions for the processors 1102-1106.

Main memory 1116 or dynamic storage device may include a magnetic disk or an optical disc for storing information and instructions. I/O device 1130 may include a display device (not shown), such as a cathode ray tube (CRT) or liquid crystal display (LCD), for displaying information to an end user. For example, graphical and/or textual indications of installation status, time remaining in the trial period, and other information may be presented to the prospective purchaser on the display device. I/O device 1130 may also include an input device (not shown), such as an alphanumeric input device, including alphanumeric and other keys for communicating information and/or command selections to the processors 1102-1106. Another type of user input device includes cursor control, such as a mouse, a trackball, or cursor direction keys for communicating direction information and command selections to the processors 1102-1106 and for controlling cursor movement on the display device.

System 1100 may also include a communication device (not shown), such as a modem, a network interface card, or other well-known interface devices, such as those used for coupling to Ethernet, token ring, or other types of physical attachment for purposes of providing a communication link to support a local or wide area network, for example. Stated differently, the system 1100 may be coupled with a number of clients and/or servers via a conventional network infrastructure, such as a company's Intranet and/or the Internet, for example.

It is appreciated that a lesser or more equipped system than the example described above may be desirable for certain implementations. Therefore, the configuration of system 1100 may vary from implementation to implementation depending upon numerous factors, such as price constraints, performance requirements, technological improvements, and/or other circumstances.

It should be noted that, while the embodiments described herein may be performed under the control of a programmed processor, such as processors 1102-1106, in alternative embodiments, the embodiments may be fully or partially implemented by any programmable or hardcoded logic, such as field programmable gate arrays (FPGAs), transistor transistor logic (TTL) logic, or application specific integrated circuits (ASICs). Additionally, the embodiments of the invention may be performed by any combination of programmed general-purpose computer components and/or custom hardware components. Therefore, nothing disclosed herein should be construed as limiting the various embodiments of the invention to a particular embodiment wherein the recited embodiments may be performed by a specific combination of hardware components.

In the above description, numerous specific details such as logic implementations, opcodes, resource partitioning, resource sharing, and resource duplication implementations, types and interrelationships of system components, and logic partitioning/integration choices may be set forth in order to provide a more thorough understanding of various embodiments of the invention. It will be appreciated, however, to one skilled in the art that the embodiments of the invention may be practiced without such specific details, based on the disclosure provided. In other instances, control structures, gate level circuits and full software instruction sequences have not been shown in detail in order not to obscure the invention. Those of ordinary skill in the art, with the included descriptions, will be able to implement appropriate functionality without undue experimentation.

The various embodiments of the invention set forth above may be performed by hardware components or may be embodied in machine-executable instructions, which may be used to cause a general-purpose or special-purpose processor or a machine or logic circuits programmed with the instructions to perform the various embodiments. Alternatively, the various embodiments may be performed by a combination of hardware and software.

Various embodiments of the invention may be provided as a computer program product, which may include a machine-readable medium having stored thereon instructions, which may be used to program a computer (or other electronic devices) to perform a process according to various embodiments of the invention. The machine-readable medium may include, but is not limited to, floppy diskette, optical disk, compact disk-read-only memory (CD-ROM), magneto-optical disk, read-only memory (ROM) random access memory (RAM), erasable programmable read-only memory (EPROM), electrically erasable programmable read-only memory (EEPROM), magnetic or optical card, flash memory, or another type of media/machine-readable medium suitable for storing electronic instructions. Moreover, various embodiments of the invention may also be downloaded as a computer program product, wherein the program may be transferred from a remote computer to a requesting computer by way of data signals embodied in a carrier wave or other propagation medium via a communication link (e.g., a modem or network connection).

Similarly, it should be appreciated that in the foregoing description, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Whereas many alterations and modifications of the invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as the invention.

What is claimed is:

1. A method, comprising:
determining data dependencies within a sequence of instructions;
identifying a store-load instruction pair within the sequence of instructions;
identifying one or more stack location insensitive sequences between the store-load instruction pair;
reordering the one or more stack location insensitive sequences based on the data dependencies to place the instructions of the store-load instruction pair immediately adjacent to each other; and
removing the store-load instruction pair.

2. The method of claim 1, wherein the one or more stack location insensitive sequences encompass one or more instructions having a data dependency with an instruction prior to a store instruction of the store-load instruction pair.

3. The method of claim 1, wherein the identifying stack location insensitive sequences comprises:
determining whether a stack balance of a stack is unchanged after executing a portion of the sequence of instructions; and
determining whether one or more of stack elements already existing in the stack before the execution of the portion of the sequence of instructions is utilized during the execution.

4. The method of claim 1, wherein identifying a store-load instruction pair comprises:
determining whether the store instruction of a store-load instruction pair is executed previous to a load instruction of the store-load instruction pair;
determining whether the store instruction and the load instruction access the same local variable;
determining whether the local variable exists out of a basic block that includes the store instruction and the load instruction; and
determining whether one or more instructions between the store instruction and the load instruction are dependent on the store instruction.

5. The method of claim 1, wherein the sequence of instructions comprises stack-based language instructions.

6. The method of claim 4, wherein the stack-based language instructions are Java bytecode.

7. The method of claim 4, wherein the stack-based language instructions are Microsoft Intermediate Language.

8. The method of claim 1, wherein reordering the stack location insensitive sequences comprises moving a stack location insensitive sequence above an instruction sequence if the stack location insensitive sequence does not depend on the instruction sequence.

9. The method of claim 1, wherein reordering the stack location insensitive sequences comprises moving a stack location insensitive sequence below an instruction sequence if the instruction sequence does not depend on the stack location insensitive sequence.

10. The method of claim 1, wherein the reordering the stack location insensitive sequences and the removing the store-load pair are performed by a compiler.

11. A machine-accessible medium having stored thereon data representing sets of instructions that, when executed by a machine, cause the machine to perform operations comprising:
determining data dependencies within a sequence of instructions;
identifying a store-load instruction pair within the sequence of instructions;
identifying one or more stack location insensitive sequence between the store-load instruction;
reordering the one or more stack location insensitive sequences based on the data dependencies to place the instructions of the store-load instruction pair immediately adjacent to each other; and
removing the store-load instruction pair.

12. The machine-accessible medium of claim 11, wherein the one or more stack location insensitive sequences encompass one or more instructions having a data dependency with an instruction prior to a store instruction of the store-load instruction pair.

13. The machine-accessible medium of claim 11, wherein identifying stack location insensitive sequences comprises:
determining whether a stack balance of a stack is unchanged after executing a portion of the sequence of instructions; and
determining whether one or more stack elements already existing in the stack before the execution of the portion of the sequence of instructions is utilized during the execution.

14. The machine-accessible medium of claim 11, wherein identifying a store-load instruction pair comprises:
determining whether a store instruction of a store-load instruction pair is executed previous to a load instruction of the store-load instruction pair;
determining whether the store instruction and the load instruction access the same local variable;
determining whether the local variable exists out of a basic block that includes the store instruction and the load instruction; and
determining whether one or more instructions between the store instruction and the load instruction depend on the store instruction.

15. The machine-accessible medium of claim 11, wherein the sequence of instructions comprises stack-based language instructions.

16. A system, comprising:
a storage medium, and
a processor coupled with the storage medium, the processor to:
determine data dependencies within a sequence of instructions;
identify a store-load instruction pair within the sequence of instructions;
identify one or more stack location insensitive sequences between the store-load instruction pair;
reorder the one or more stack location insensitive sequences based on the data dependencies to place the two instructions of the store-load instruction pair immediately adjacent to each other; and
remove the store-load instruction pair.

17. The system of claim 16, wherein the one or more stack location insensitive sequences encompass one or more instructions having a data dependency with an instruction prior to a store instruction of the store-load instruction pair.

18. The system of claim 16, wherein the identifying stack location insensitive sequences comprises:
determining whether a stack balance of a stack is unchanged after executing a portion of the sequence of instructions; and
determining whether one or more stack elements already existing in the stack before the execution of the portion of the sequence of instructions is utilized during the execution.

19. The system of claim 16, wherein identifying one or more store-load instruction pairs comprises:
determining whether a store instruction of a store-load instruction pair is executed previous to a load instruction of the store-load instruction pair;
determining whether the store instruction and the load instruction access the same local variable;
determining whether the local variable exists out of a basic block including the store instruction and the load instruction; and
determining whether one or more instructions between the store instruction and the load instruction depend on the store instruction.

20. The system of claim 16, wherein the sequence of instructions comprises stack-based language instructions.
